(19) United States
(12) Patent Application Publication
(10) Pub. No.: US 2005/0159030 A1
(43) Pub. Date: Jul. 21, 2005

(54) Standoff connector

(75) Inventor: Cheng-Chung Hsu, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/760,408

(22) Filed: Jan. 21, 2004

(51) Int. Cl. H01R 12/16

(52) U.S. Cl. 439/74

(57) ABSTRACT

The present invention is to provide a standoff connector comprising a body having a base at a lower end thereof, at least one flexible wing disposed on a surface of the body and being spaced from the base by a distance, a neck disposed at a top end of the body, and a handle disposed at a top end of the neck. When the body is inserted into an opening of a board, the board can be clamped between the base and the wing. The handle is adapted to insert into an elongated clearance opening of another board for urging the another board against the body while the handle being rotated about 90 degrees to the position perpendicular to the clearance opening.

### FIELD OF THE INVENTION

The present invention relates to standoff connectors and more particularly to a circuit board standoff connector with improved characteristics.

### BACKGROUND OF THE INVENTION

Conventionally, 1U servers are widely used by many companies and ISPs (Internet service providers) so as to mount a relatively large number of 1U servers in a limited space, thereby meeting the high data transfer rate of network. 1U servers can be stacked in a box like stacking books. More CPUs (central processing units) mounted in a single box makes an intensive calculation possible. This is because required power and generated heat of the CPUs of a 1U server are much less than that of a single CPU of a conventional server. Further, heat dissipation arrangement and power system can be shared by 1U servers. Hence, high operation efficiency still can be obtained in such small operation architecture. Also, cable maintenance can be simplified since each box has dedicated cable and power cord. Moreover, each blade server and all components of a box can be replaced if desired. As a result, maintenance of the whole platform is much easier.

1U is the specifications about housing height of a server set by the related art. Specifically, housing height of the server is 1.75 inch. 1U server comprises a plurality of electronic elements for achieving specific purposes in addition to a mother board in a very narrow space. For increasing its processing feature, many expansion cards are additionally mounted on the mother board. These expansion cards are comprised of SCSI (Small Computer System Interface), IDE (Integrated Drive Electronics), PCI (Peripheral Component Interconnect), and USB (Universal Serial Bus) expansion cards. As an end, the desired increase of processing feature of the 1U server can be obtained.

However, only one technique is used in assembling the expansion cards onto the mother board due to a limited height of the server. The technique involves horizontally disposing the stud, changing its insertion direction by means of a direction change connector, and inserting the expansion card into a slot of the mother board. This can overcome the limited height of the server. However, such assembly technique can weaken the support and fastening of the expansion card on the mother board. Also, the expansion card tends to vibrate, resulting in a loosening of the expansion card at a coupling portion of the direction change connector. It may break down the machine or even damage golden fingers of the expansion card. Thus, an improved support and fastening mechanism is desired for reducing inconvenience and trouble associated with replacing or installing an expansion card as well as future use. Otherwise, many users may complain much about support and fastening of the assembled expansion card. To the worse, many users may be discouraged in buying and installing a new expansion card. This is a big blow to the expansion card market.

In another aspect, for meeting the vast market of server a server manufacturer has to not only maintain high quality but also increase the assembly speed and provide more powerful features to servers. Thus, a speed increase of assembly line, particularly the quick and reliable fastening of an expansion card on the mother board, play a critical role in the increase of computer production. In this regard, a standoff connector is provided for supporting an expansion card on a mother board and fastening the same. Such disclosure can be found in U.S. Pat. Nos. 4,502,193, 4,674,930, 4,786,225, and 5,754,412 in which each disclosed a standoff connector comprising two independent elements.

Important characteristics of U.S. Pat. No. 5,754,412 are illustrated in FIG. 1. As shown, there is provided a standoff connector comprising a body 10 and a stud 12. The body 10 comprises a base 102 and a trunk 104. Two opposite flexible cantilever snap lugs 106 are formed on both sides of the trunk 104 and are proximate the base 102. A central opening 108 is provided on top of the trunk 104 opposite the base 102. The stud 12 comprises a shaft 122 and a handle 124. The shaft 122 is adapted to tightly insert into the opening 108 so as to leave a distance between the handle 124 and the opening 108 sufficient to sandwich a mother board 14. When the body 10 is mounted on the mother board 14, the mother board 14 can be clamped by the base 102 and the lugs 106. As a result, the body 10 is fastened on the mother board 14. For mounting an expansion card 16 on the connector, insert the handle 124 into a clearance opening 160 of the expansion card 16. Next, rotate the handle 124 to be perpendicular to the opening 160 in which the handle 124 is rested upon the expansion card 16. As an end, the expansion card 16 can be stably supported and fastened above the mother board 14 by the standoff connector. The above description is only a portion (e.g., independent claim 1) of claims claimed by U.S. Pat. No. 5,754,412. Other portions of the independent claim 1 are not described herein for the sake of brevity since they are fully described in the patent.

From accompanying drawings and independent claim 1 of each of U.S. Pat. Nos. 4,502,193, 4,674,930, 4,786,225, and 5,754,412, it is found that each disclosed a standoff connector comprising two independent elements. Also, their components are structurally complicated and thus can adversely affect the production. For example, molds associated with respective components are difficult of being prepared, resulting in an increase of the manufacturing cost. Moreover, each of the above patents disclosed an installation procedure of mounting the body of the connector on the mother board, mounting the expansion card on the stud, and fastening the stud onto the expansion card. Such installation procedure has no effect to increase the speed of assembly line. Thus, the need for improvement still exists.

### SUMMARY OF THE INVENTION

A primary object of the present invention is to provide a standoff connector comprising a body, a base disposed at a lower end of the body, at least one flexible wing disposed on a surface of the body, the wing being spaced from the base by a distance, a neck disposed at a top end of the body, and a handle disposed at a top end of the neck. A board can be clamped between the base and the wing when the body is inserted into an opening of the board. Hence, the body is secured to the board and is prevented from falling from the opening. Also, the handle is adapted to insert into an elongated clearance opening of another board for causing the another board to urge against the body while the handle being rotated about 90 degrees to a position perpendicular to the clearance opening. As such, another board will be fastened between the handle and the neck. As an end, the purpose of stably supporting and fastening another board above one board by the standoff connector is achieved. By utilizing the present invention, the above drawbacks of the prior art can be overcome.

The above and other objects, features and advantages of the present invention will become apparent from the following detailed description taken with the accompanying drawings.

### BRIEF DESCRIPTION OF THE DRAWINGS

FIG. 1 is a cross-sectional view of a conventional standoff connector mounted between a mother board and an expansion card;

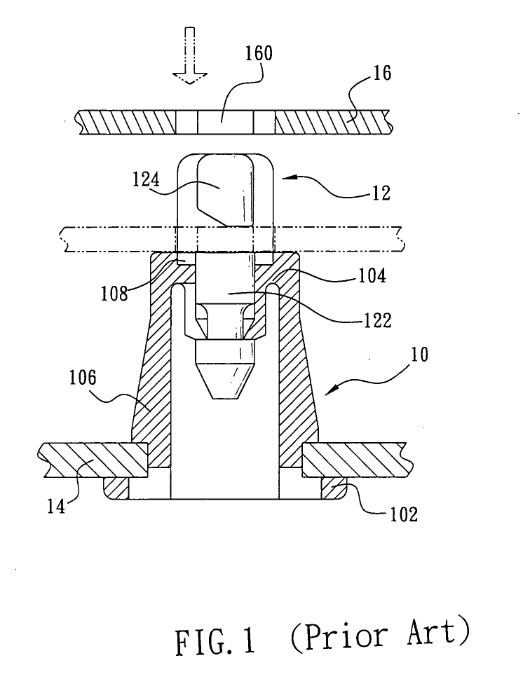

FIG. 2 is an exploded, perspective view of a preferred embodiment of standoff connector according to the invention, the connector being mounted between two boards; and

FIG. 3 is a side view in part section illustrating the mounting of the connector between boards.

### DETAILED DESCRIPTION OF THE PREFERRED EMBODIMENTS

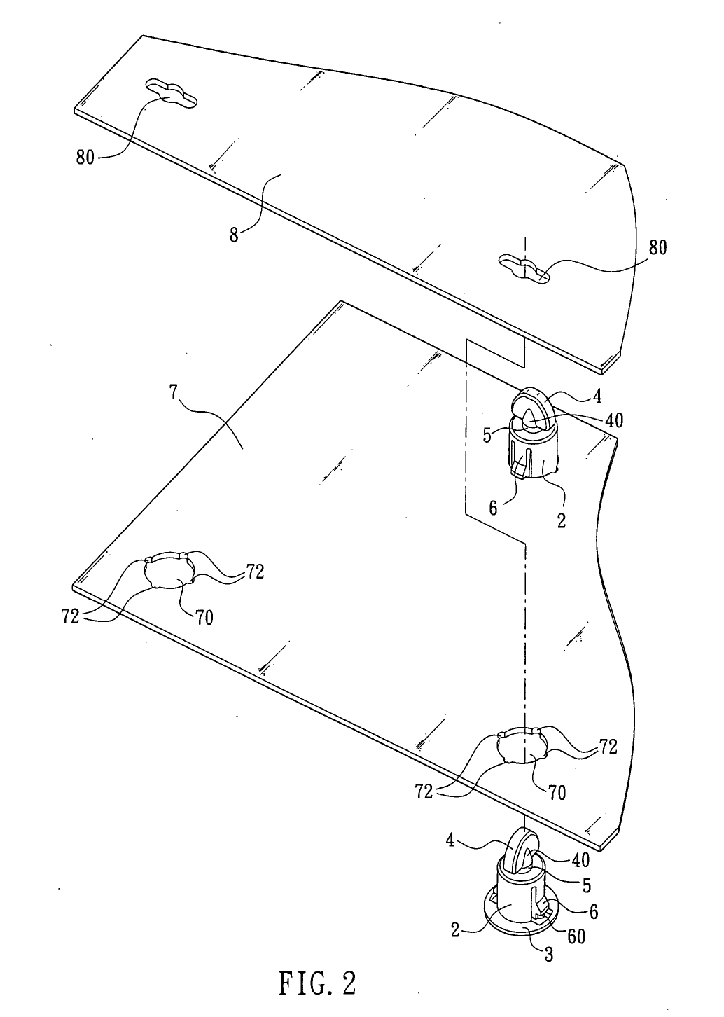

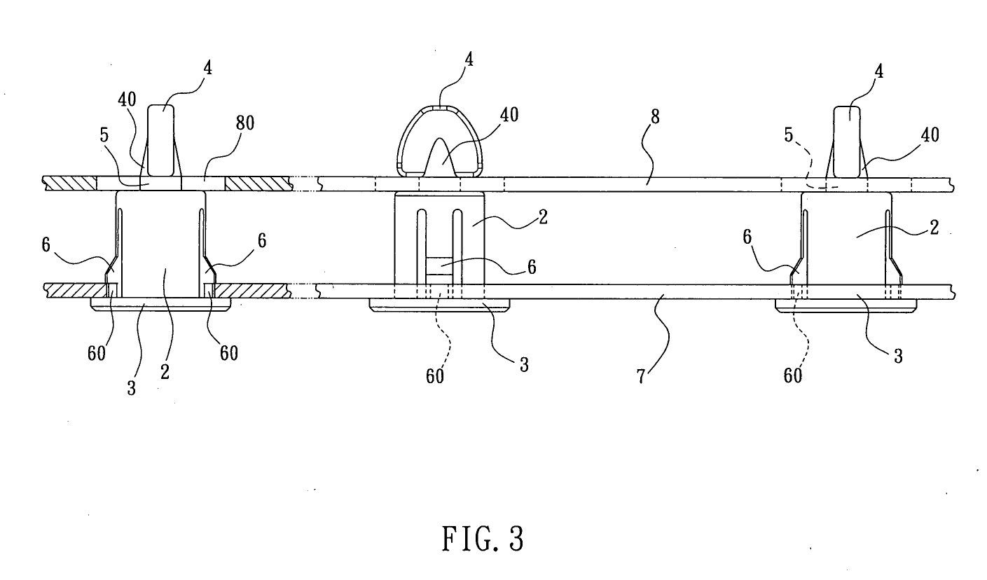

Referring to FIGS. 2 and 3, there is shown a standoff connector in accordance with the invention comprising a cylindrical body 2 including a circular base 3 having a diameter (i.e., section) larger than that of the body 2, a top rotatable handle 4, a rotatable neck 5 interconnected the handle 4 and the body 2, the neck 5 having a diameter (i.e., rotation radius) smaller than that of the handle 4, and two opposite flexible wings 6 on a surface of the body 2. The wings 6 are spaced from the base 3 by a distance. There is also shown a board (e.g., mother board) 7 to be secured to the body 2. The board 7 comprises a substantially circular opening 70 having a diameter to permit the body 2 to insert into. Thus, a bottom surface of the board 7 is secured to the base 3 and a top surface thereof is secured to the wings 6. That is, the board 7 is tightly sandwiched by the base 3 and the wings 6. As such, the body 2 is secured to the board 7. There is also provided another board (e.g., expansion card) 8 to be secured to the body 2. The board 7 comprises an elongated clearance opening 80 having a length to permit the handle 4 to insert into for urging the body 2 against the board 8. Next, an about 90 degrees rotation of the handle 4 will cause the handle 4 to be perpendicular to the opening 80. As such, the board 8 will be fastened between the handle 4 and the neck 5 (FIG. 3). As an end, the purpose of stably supporting and fastening another board 8 above one board 7 by the standoff connector is achieved.

In brief, a unitary element (i.e., standoff connector) is embodied by the invention for achieving the purpose of stably supporting and fastening another board 8 above one board 7. As compared with prior construction comprising two independent elements, the invention is much simple and is less structurally complicated with respect to shape and construction. This in turn can save the cost of preparing molds, resulting in a reduction in the manufacturing cost. Most importantly, assembly of the standoff connector of the invention is much simple and fast as compared with that of prior one. Hence, a significant speed increase of assembly line is obtained by the invention. Particularly, the fastening of another board 8 is much stable.

In the invention a tab 60 is provided at a lower end of the wing 6 spaced from the base 3. The tab 60 has a thickness no more than a maximum thickness of the wing 6. Further, a plurality of (four as shown) equally spaced recesses 72 are formed around an edge of the opening 70. The recesses 72 are sized to conform to the tabs 60. As such, the body 2 can be tightly fastened at the board 7 after properly fitting the tabs 60 in the recesses 72 by rotating the body 2. At this position, a rotation of the body 2 is made possible only by rotating the handle 4 to squeeze the tabs 60 inwardly to clear from the recesses 72. Further, with the provision of both the tabs 60 and the recesses 72, an audible click can be produced when the handle 4 is properly installed by rotation and a proper location of the body 2 during the rotation can also be indicated.

In the invention two smooth projections 40 are formed at opposite sides of the handle 4. The provision of the projections 40 aims at properly installing the board 8 on the body 2. Otherwise, a proper installation (i.e., insertion direction) of the board 8 on the body 2 is not possible. Further, such can limit the body 2 to only fasten at the opening 80 of another board 8 conformed to the shapes of the handle 4 and the projections 40. This can prevent the body 2 from installing at a board 8 having different specifications.

While the invention has been described by means of specific embodiments, numerous modifications and variations could be made thereto by those skilled in the art without departing from the scope and spirit of the invention set forth in the claims.

1. A standoff connector, comprising:
a body;
a base disposed at a lower end of the body, the base having a section less that of the body;
a rotatable handle disposed at a top end of the body;
a rotatable neck interconnected the handle and the body, the neck having a rotation radius than that of the handle; and
at least one flexible wing disposed on a surface of the body, the wing being spaced from the base by a distance.

2. The standoff connector of claim 1, further comprising a tab disposed at a lower end of the wing spaced from the base.

3. The standoff connector of claim 2, wherein the tab has a thickness no more than a maximum thickness of the wing.

4. The standoff connector of claim 2, wherein the handle comprises two projections at opposite sides thereof.
